(19) United States
(12) Patent Application Publication
(10) Pub. No.: US 2022/0228886 A1
(43) Pub. Date: Jul. 21, 2022

(54) MISSING MAP DATA IDENTIFICATION SYSTEM

(71) Applicant: Uber Technologies, Inc., San Francisco, CA (US)

(72) Inventors: Shivendra Pratap Singh, Redwood City, CA (US); Krishna Aditya Gabbita, San Mateo, CA (US); Jayanth Mahalingam, Fremont, CA (US); Aditya Somani, Ajmer (IN); Anand Karthik Tumuluru, Sunnyvale, CA (US); Konstantin Stulov, San Francisco, CA (US)

(21) Appl. No.: 17/580,393

(22) Filed: Jan. 20, 2022

Related U.S. Application Data
(60) Provisional application No. 63/140,132, filed on Jan. 21, 2021.

(51) Int. Cl. G01C 21/00

(52) U.S. Cl. CPC G01C 21/3859; G01C 21/3815; G01C 21/3811

(57) ABSTRACT

A transportation management system analyzes data characterizing trips associated with an access point where a rider is picked up by, or dropped off by, a driver. The transportation management system determines trip metrics for the access point based on the data. The transportation management system identifies an access point defect for the access point using the trip metrics. The transportation management system flags the access point as associated with a missing road segment responsive to identifying the access point defect. The transportation management system performs a resolution action to address the access point defect.

### CROSS REFERENCE TO RELATED APPLICATIONS

This application claims the benefit of U.S. Provisional Application No. 63/140,132, filed Jan. 21, 2021, which is hereby incorporated in its entirety by reference.

### BACKGROUND

The described embodiments generally relate to transportation management systems, and more particularly to identifying data missing from geographic data used to facilitate trips.

Transportation management systems provide support for logistical issues in managing the transportation of people, cargo, or the like. In some systems, a driver provides transportation services to a user requesting a trip from a pick-up location to a drop-off location selected by the requesting user. Transportation management systems use map data to facilitate trips, such as for rider selection of pick-up or drop-off locations, and for providing navigation services to a driver (e.g., from a pick-up location to a drop-off location).

However, the pick-up and drop-off locations may be inconsistent with some map data, such as pick-up or drop-off locations that are not accessible by any road segments included in the geographic data. In such cases, the transportation management system may perform automatic adjustments to the pick-up or drop-off locations to conform to the available map data (e.g., select the nearest geographic location on a street segment). These automatic adjustments may negatively impact trip execution, such as by increasing a distance between intended pick-up or drop-off locations and adjusted pick-up or drop-off locations and increasing trip duration. Some conventional systems further facilitate trips without making any adjustments to account for missing map data, forcing riders and drivers to manually coordinate logistics on the ground. These approaches by conventional systems result in extended trip durations, increased cancellations, and inefficient and negative rider and driver user experiences. As such, transport management systems that address trip issues resulting from missing map data are needed.

### BRIEF DESCRIPTION OF THE DRAWINGS

FIG. 1 illustrates the system environment for a transportation management system, in accordance with an embodiment.

FIG. 2 illustrates an embodiment of a transportation management system, in accordance with an embodiment.

FIG. 3 illustrates a visualization of map data representing an access point associated with a missing road segment, in accordance with an embodiment.

FIG. 4 illustrates a user interface for adjusting a user experience for a driver to account for a missing road segment, in accordance with an embodiment.

FIG. 5 is a flowchart illustrating a method for identifying a missing road segment associated with an access point, in accordance with an embodiment.

FIG. 6 illustrates example components of a computer used as part or all of the network system, the rider client device, and/or the driver client device, in accordance with an embodiment.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

### I. System Overview

A transportation management system analyzes data characterizing trips associated with an access point where a rider is picked up by, or dropped off by, a driver. The transportation management system determines trip metrics for the access point based on the data. The transportation management system identifies an access point defect for the access point using the trip metrics. The transportation management system flags the access point as associated with a missing road segment responsive to identifying the access point defect. The transportation management system performs a resolution action to address the access point defect. As such, the transportation management system dynamically updates map systems to improve the utility of the transportation management system to coordinate trips.

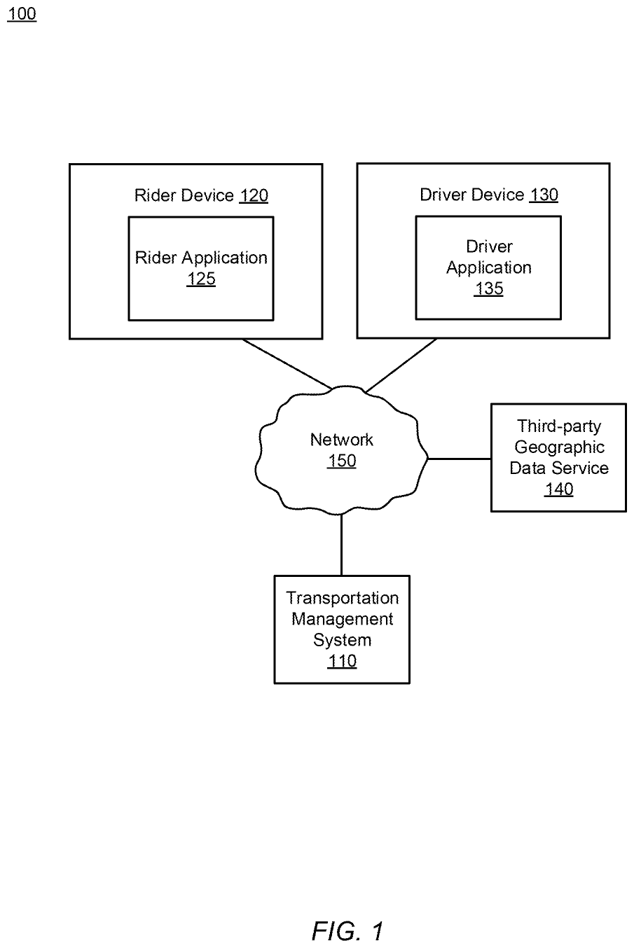

Turning now to the specifics of the system architecture, FIG. 1 illustrates a system environment 100 for a transportation management system 110. In the embodiment shown, the system environment 100 includes a transportation management system 110, a rider device 120, a driver device 130, a third-party geographic data service 140, and a network 150. In other embodiments, the system environment 100 includes different or additional elements. Furthermore, the functionality may be distributed among the elements in a different manner than described.

The transportation management system 110 coordinates the transportation of persons or goods/items for a rider by a service provider (e.g., a driver of a vehicle). The term “rider” is used herein to refer to a user who requests transportation services from the transportation management system 110 to transport themselves, other individuals, or goods/items. As such, a rider is not necessarily transported as part of a trip requested by the rider. The driver uses a vehicle to provide the transportation services to the rider from a pick-up access point (e.g., a pick-up location) to a drop-off access point (e.g., a drop-off location). The transportation management system 110 communicates with the rider device 120 and the driver device 130 in order to facilitate a trip from the pick-up access point to the drop-off access point. For example, the transportation management system 110 may analyze historical trip data, such as by using machine learning or other statistical techniques, in order to identify geographic positions that are at or near locations where riders are frequently picked up or dropped off. For instance, locations with a pick-up or drop-off frequency above a threshold. The access points may be stored in a set of digital map data used by the transportation management system 110 to facilitate trips. The transportation management system 110 may obtain map data directly, such as from the rider device 120 or driver device 130, or may obtain map data from third-party map data providers, such as from the third-party geographic data service 140, as described below.

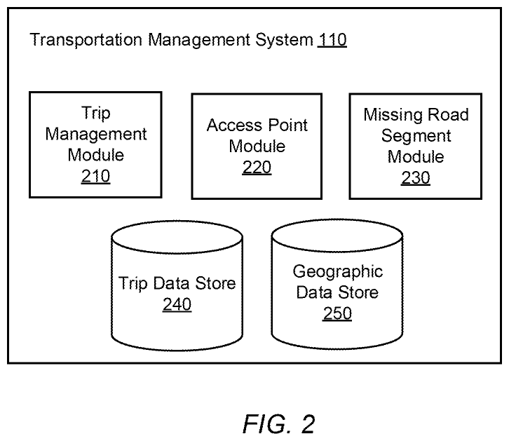

Furthermore, the transportation management system 110 identifies access points associated with missing map data. In embodiments, the transportation management system 110 determines that an access point may be associated with missing map data by evaluating trip metrics associated with the access point. Trip metrics are data values that describe measurements for characteristics of trip execution, such as an access point distance error (e.g., the distance between the actual access point and an adjusted access point used for a trip), a cancellation of the trip by the rider or driver, a number of trip requests including the access point, an estimated time of arrival (ETA) error for the access point, a total number of trips including the access point, a trip duration, etc. The trip metric values can be determined based on data describing one or more trips using various statistical methods (e.g., counts, averages, modes, frequencies, etc.). For example, trip metrics may include an average access point distance error value, an average cancellation rate value, an average trip request rate value, an average trip duration value, etc. The transportation management system 110 evaluates the trip metrics associated with an access point in order to determine whether the access point is associated with one or more access point defects indicative of missing map data (e.g., missing road segments). The term “access point defect,” as used herein, refers to a discrepancy between expected trip execution and observed trip execution. For instance, the transportation management system 110 may determine one or more access point defects based on whether one or more of the trip metrics are above or below respective thresholds indicating possible missing map data (i.e., defect indicator thresholds). If the transportation management system does determine the access point is associated with one or more trip defects, the transportation management system 110 can perform one or more actions to determine whether the trip defects are due at least in part to missing map data, such as via review by an administrator. If missing map data is identified, the transportation management system 110 can attempt to resolve issues resulting from the missing map data. For instance, the transportation management system 110 can communicate with the third-party map data service 140 to obtain the missing map data and use the missing map data to facilitate trips. In the same or different embodiments, the transportation management system 110 adjusts the user experience for a driver or a rider for a trip involving an access point associated with missing map data. These and other embodiments are described in greater detail below with reference to FIGS. 2-5.

A rider operates a client device that executes a rider application 125 (i.e., a rider device 120) that communicates with the transportation management system 110. The term “rider” as used herein refers to a user who requests transportation services from the transportation management system 110 for themselves, other individuals, or other items, and therefore is not necessarily transported as part of a trip resulting from the request. The rider interacts with the rider application 125 using the rider device 120 to coordinate transportation services through the transportation management system 110. For instance, the rider can make a request for a trip from the transportation management system 110, such as a delivery of items, such as cargo needing transport, or transportation for the rider or additional persons. The rider application 125 enables the rider to specify access points for a trip, such as a pick-up access point or a drop-off access point for the trip. A pick-up access point or drop-off access point may be a location input by the rider or may correspond to the current location of the rider device 120, such as determined by a global positioning system (GPS) component of the rider device 120, a wireless networking system, or a combination thereof. For purposes of simplicity, as described herein, a pick-up or drop-off access point can include a pick-up or drop-off location, respectively, for a trip which is (i) determined by the rider application 125 (e.g., based on the current location of the rider device 120 using a GPS component), (ii) specified or selected by the rider, or (iii) determined by the transportation management system 110. In some embodiments, the transportation management system 110 recommends one or more access points for a trip to a rider based on historical trip data and environmental characteristics associated with the location of an access point or location of the rider device 120.

In the same or different embodiments, the transportation management system 110 may determine an adjusted access point based on an intended access point selected by the rider or otherwise determined by the transportation management system 110. In particular, the transportation management system can use available map data to identify a geographic position along an appropriate road segment to use as a pick-up or drop-off access point instead of an intended access point (e.g., the road segment nearest to the access point). In this case, the transportation management system 110 can automatically adjust the intended access point to an access point on an identified road segment (i.e., an adjusted access point). The adjusted access point may be an existing access point managed by the transportation management system 110, or may be a new location selected during trip execution based on its proximity to a road segment and the intended access point (e.g., the nearest geographic position along an available road segment).

According to examples herein, the rider device 120 can transmit a set of data (referred to herein as “service data”) to the transportation management system 110 over the network(s) 140 in response to rider input or operation of the rider application 125. Such service data can be indicative of the rider's interest in potentially requesting a trip (e.g., before actually confirming or requesting the trip). For example, the rider may launch the rider application 125 and specify an origin location or a destination location to view information about a trip before making a decision on whether to request the trip. The rider may want to view information about the average or estimated time of arrival for pick up by a driver, the estimated time to the destination, the price, the available transportation service types, etc. Depending on implementation, the service data can include the geographic position of the rider device 120, information describing an origin or destination location desired by the rider, rider information (e.g., an account identifier), application information (e.g., version number), a rider device 120 identifier or type, etc. According to some examples, each time the rider modifies the origin or destination location, the rider application 125 can generate and transmit the service data to the transportation management system 110.

Once the rider confirms or orders a trip via the rider application 125, the rider application 125 can generate data corresponding to a request for the trip through the transportation management system 110 (i.e., a trip request). Responsive to receiving a trip request, the transportation management system 110 uses information from the trip request to match the rider with a driver among one or more available drivers. Depending on the implementation, the trip request can include rider or device information (e.g., a rider identifier, a device identifier), a transportation service type (e.g., vehicle type), a pick-up location, a drop-off location, a payment profile identifier, or other data. The transportation management system 110 selects a driver from a set of drivers, such as based on the driver's current location and status (e.g., offline, online, available, etc.) or information from the trip request (e.g., transportation service type, pick-up location, or drop-off location), to provide the trip for the rider and transport the rider (or other individuals or items) from the pick-up location to the drop-off location. Responsive to selecting an available driver, the transportation management system 110 sends an invitation message to the driver device 130 inviting the driver to fulfill the trip request.

The driver operates a client device that executes a driver application 135 (i.e., a driver device 130) that communicates with the transportation management system 110. The driver interacts with the driver application 135 using the driver device 130 to provide information indicating whether the driver is available or unavailable to provide transportation services to riders. The driver application 135 can also present information about the transportation management system 110 to the driver, such as invitations to provide trips, navigation instructions, map data, etc. In some embodiments, the driver application 135 enables the driver to provide information regarding availability of the driver by logging into the transportation management system 110 and activating a setting indicating that they are currently available to provide trips. The driver application 135 also provides the current location of the driver or the driver device 130 to the transportation management system 110. Depending on implementation, the current location may be a location input by the driver or may correspond to the current location of the driver device 130 as determined by a GPS component of the driver device 130, a wireless networking system, or a combination thereof. The driver application 135 further allows a driver to receive, from the transportation management system 110, an invitation message to provide a trip for a requesting rider, and if the driver accepts via input, the driver application 135 can transmit an acceptance message to the transportation management system 110. The transportation management system 110 can subsequently provide information about the driver to the rider application 125 on the rider device 120. In the same or different embodiment, the driver application 135 can enable the driver to view a list of current trip requests and to select a particular trip request to fulfill. The driver application 135 can also receive routing information from the transportation management system 110. The driver application 135 enables a driver to provide a rating for a rider upon completion of a trip. In one embodiment, the rating is provided on a scale of one to five, five being the maximal (best) rating.

The rider device 120 and the driver device 130 are portable electronic devices such as smartphones, tablet devices, wearable computing devices (e.g., smartwatches) or similar devices. Alternatively, the driver device 130 can correspond to an on-board computing system of a vehicle. Client devices typically have one or more processors, memory, touch screen displays, wireless networking system (e.g., IEEE 802.11), cellular telephony support (e.g., LTE/GSM/UMTS/CDMA/HSDPA, etc.), and location determination capabilities.

The rider device 120 and the driver device 130 interact with the transportation management system 110 through client applications (i.e., the rider application 125 and driver application 135, respectively) configured to interact with the transportation management system 110. The rider application 125 and the driver application 135 can present information received from the transportation management system 110 on a rider interface, such as a map of the geographic region, and the current location of the rider device 120 and/or the driver device 130. The rider application 125 and the driver application 135 can determine the current location of the respective device and provide the current location to the transportation management system 110.

The third-party geographic data service 140 is a third-party provider of geographic data including map data, traffic data, or other geographic information. For instance, the third-party geographic data service 140 may be a geographic information system, such as Esri™ Google™, TomTom™, etc. The third-party geographic data service 140 may provide an application programming interface (API) to client systems in order to facilitate request and retrieval of geographic data by the client systems, such as the transportation management system 110.

The network 150 connects the various components of the system environment 100. The network 150 may be any suitable communications network for data transmission. In an embodiment such as that illustrated in FIG. 1, the network 150 uses standard communications technologies or protocols and can include the internet. In another embodiment, some or all of the components of the system environment 100 use custom or dedicated data communications technologies.

### II. Transportation Management System

FIG. 2 illustrates an embodiment of the transportation management system 110. In the embodiment shown, the transportation management system 110 includes a trip management module 210, an access point module 220, a missing road segment module 230, a trip data store 240, and a geographic data store 250. In other embodiments, there may be different or additional components than those shown in FIG. 2. Furthermore, some or all of the operations described for the transportation management system 110 below may be performed on the rider device 120, the driver device 130, or another suitable device.

The trip management module 210 is configured as a communicative interface between the rider application 125, the driver application 135, and the various modules and data stored in the transportation management system 110, and is one means for performing this function. The trip management module 210 receives driver availability status information and current location information from the driver application 135 and updates the trip data store 240 with the availability status. The trip management module 210 also receives trip requests from the rider application 125 and creates corresponding trip records in the trip data store 240. According to an example, a trip record corresponding to a trip request can include or be associated with a trip ID, a rider ID, a pick-up access point, a drop-off access point, a transportation service type, pricing information, a status indicating that the corresponding trip request has not been processed, a trip duration, a trip route, a trip pick-up time, a trip drop-off time, and any other trip data described below with reference to the trip data store 240. According to one example, when a driver accepts the invitation message to service a trip request for a rider, the trip record can be updated with the driver's information as well as the driver's location and the time when the trip request was accepted. Similarly, location and time information about the trip as well as the cost for the trip can be associated with the trip record.

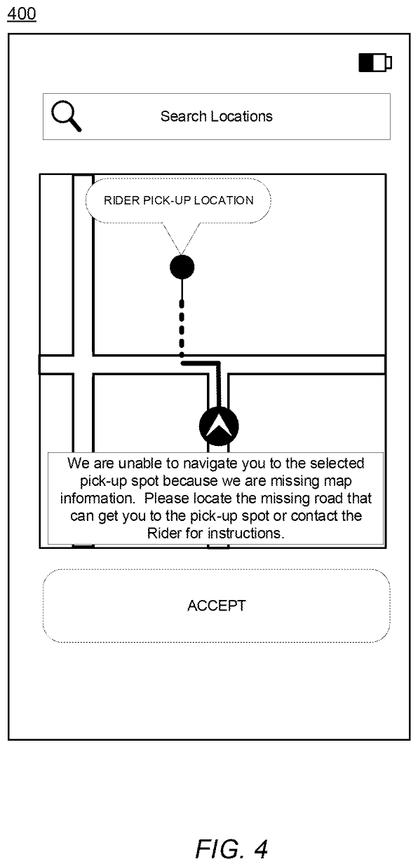

The trip management module 210 further communicates with the access point module 220 in order to identify a set of candidate access points for a trip request. In embodiments, a rider can initiate the process of requesting a trip on the rider device 120 via the rider application 125, during which process the rider application 125 and the trip management module 210 may communicate back and forth in order to complete a trip request. For example, the trip management module 210 can receive service data from the rider device 120, as described above with reference to the rider device 120. As part of the process of requesting a trip, the trip management module 210 may provide service data to the access point module 220 (e.g., the location of the rider device 120, an intended destination location for a trip, an identifier of an account of the rider stored on the transportation management system 110, etc.). Based on the provided service data, the trip management module 210 may receive one or more candidate access points for the trip (e.g., pick-up or drop-off access points) from the access point module 220. Selection of access points by the access point module 220 is described in greater detail below. The trip management module 210 may then provide the one or more candidate access points to the rider device 120 in order for the rider to select a pick-up access point and a drop-off access point for the trip and confirm a trip request for a trip using the selected access points. In some embodiments, the trip management module 210 automatically creates trip requests for the rider, such as by automatically selecting a pick-up access point and/or a drop-off access point from the one or more candidate access points based on the information provided by the rider device 120. The trip management module 210 may further create trip requests for trips that use an adjusted access point, such as determined by the trip management module 210 or access point module 220. In some embodiments, the trip management module 210 communicates with the missing road segment module 230 in order to adjust the rider or driver user experience based on missing road segments, as described in greater detail below with reference to the missing road segment module 230 and FIG. 4.

In one embodiment, during execution of a trip, the trip management module 210 receives information (e.g., periodically) from the driver application 135 indicating the location of the driver's vehicle or telematics information (e.g., indications of current speed, acceleration/deceleration, events, stops, and so forth). The trip management module 210 stores the information in the trip data store 240 and can associate the information with the trip record. In some embodiments, the trip management module 210 periodically calculates the driver's estimated time of arrival (DETA) at the pick-up location and provides the DETA to the rider application 125.

The access point module 220 manages access points for trips facilitated by the transportation management system 110. In various embodiments, the access point module 220 processes historical trip data in the trip data store 240 in order to generate access points, such as locations from which trips are frequently requested or locations which are often chosen as the destination for trips. The access point module 220 may store the generated access point in the trip data store 240, the geographic data store 250, or another database (e.g., an access point store). In response to receiving service data associated with a rider device 120 in the process of requesting a trip from the trip management module 210, the access point module 220 determines a set of candidate access points for the trip in the process of being requested. The access point module 220 selects the set of candidate access points from the generated access points and provides the candidate access points to the trip management module 210. The set of candidate access points may be determined using various methods, such as some or all of the access points within a threshold distance from the location of the rider device 120 at request time or a threshold number of closest access points to the location of the rider device 120 at request time.

The missing road segment module 230 evaluates trip metrics associated with access points (e.g., stored in the trip data store 240) to identify missing road segments in map data stored in the geographic data store 250. In embodiments, the missing road segment module 230 continuously or periodically selects sets of access points, such as access points in a particular geographic region, to evaluate for missing road segments. In this case, the missing road segment module 230 determines whether an access point of the selected set of access points has one or more trip defects using historical trip data associated with the access point (e.g., related trip data in the trip data store 240). The missing road segment module 230 may determine one or more trip metrics for the access point based on the historical trip data. In particular, the missing road segment module 230 compares one or more trip metrics for the access point to respective defect indicator thresholds in order to determine whether the access point is associated with one or more trip defects indicative of a missing road segment. The missing road segment module 230 may determine a score for an access point indicating a likelihood that the access point is associated with a missing road segment (i.e., a road segment defect score). The missing road segment module 230 may determine a road segment defect score based on various factors, such as a number of trip metrics above or below a respective threshold indicator, the particular trip metrics that are above or below a respective threshold indicator, or a degree by which the trip metrics differ from a respective threshold indicator. Based on the evaluation, the missing road segment module 230 flags access points of the selected set of access points that are determined to have one or more trip defects indicating a possible missing road segment (e.g., access points with a road segment defect score that exceeds a threshold). Flagging access points includes designating the access point as being associated with a missing road segment, such as updating information describing the access point in the geographic data store 250 or storing information descripting the access point with other flagged access points. In this case, individual access points within the group of flagged access points may be associated with a lower or higher priority for being resolved, such as a priority that is proportional to missing road segment scores for the access points.

At some time after one or more access points are flagged, the missing road segment module 230 performs one or more actions to resolve issues for trips caused by missing road segments. In embodiments, the missing road segment module 230 performs one or more actions to obtain map data associated with flagged access points that is missing from the map data used by the transportation management system 110 to facilitate trips. For instance, the missing road segment module 230 may report missing road segments corresponding to flagged access points to the third-party geographic data service 140. In this case, the third-party geographic data service 140 uses reports received from the missing road segment module 230 to update map data provided to the transportation management system 110, such as by adding data describing one or more missing road segments to the map data. In the same or different embodiments, the missing road segment module 230 performs one or more actions to adjust a user experience for riders or drivers in order to account for possible missing road segments associated with flagged access points. For instance, the missing road segment module 230 may provide notifications to a rider or driver for a particular trip indicating that an access point for the trip may be located along a missing road segment. Embodiments of a user interface for notifying a rider of possible missing road segments is described in greater detail below with reference to FIG. 4.

In some embodiments, the missing road segment module 230 determines that an access point may be associated with a missing road segment based at least in part on an access point distance error exceeding a corresponding defect indicator threshold. In particular, the missing road segment module 230 determines an adjusted access point at a geographic position along a road segment (e.g., within five to ten meters) in existing map data corresponding to each of a set of access points. Using an adjusted access point, the missing road segment module 230 determines an access point distance error between the actual access point and the adjusted access point. If the access point distance error exceeds a corresponding defect indicator threshold (e.g., greater than fifty meters), the missing road segment module 230 determines that the access point is associated with a trip defect and flags the access point. The missing road segment module 230 may further rank flagged access points based on the size of the access point distance error, such as ranking flagged access points with larger access point distance errors higher than flagged access points with lower access point distance errors. Furthermore, the missing road segment module 230 may consider additional trip metrics than an access point distance error in order to flag access points. In the same or different embodiments, the missing road segment module 230 may filter the flagged access points to remove access points corresponding to the same adjusted access point.

In some embodiments, the missing road segment module 230 submits flagged access points for review by administrators of the transportation management system 110. For instance, the missing road segment module 230 may evaluate a set of access points associated with a particular region to generate a group of flagged access points from the region. The missing road segment module 230 may provide the group of flagged access points to an administrator for review, such as on a computing device of the administrator. The administrator may then evaluate the access points using other information, such as other available geographic data (e.g., images of the surface of the earth corresponding to the geographic locations of the access points), to determine whether there is a missing road segment. In this case, the administrator may provide input indicating what actions the transportation management system 110 should take relative to flagged access points in the group, such as confirm or reject the flagged access points.

In some embodiments, the missing road segment module 230 uses machine learning techniques to flag access points as possibly associated with a missing road segment. In particular, the missing road segment module 230 trains a model to predict the geographic position of missing road segments in map data used by the transportation management system 110 (i.e., a missing road segment model). As an example, the missing road segment module 230 may train the missing road segment model to predict the position of missing road segments for accessing access points. In this or other cases, the missing road segment model may receive as input trip metrics associated with specific access points. Additionally, or alternatively, the missing road segment module 230 may train the missing road segment model to predict the existence of missing road segments along some or all of entire trip routes for trips associated with access points. In this or other cases, the missing road segment model may receive as input raw trip data for trips associated with the same access points (e.g., stored in the trip data store 240). In some cases, the missing road segment model further predicts the geometry of a predicted missing road segment (e.g., a set of geographic points along the missing road segment), which the missing road segment module 230 may use to adjust the rider or driver user experience (e.g., by displaying a road segment indicated as tentative or unverified).

The missing road segment module 230 can use various machine learning or other statistical techniques to train and apply a missing road segment model. These techniques can include supervised neural networks (e.g., convolutional neural networks), support vector machines, linear regression, logistic regression, decision trees, and any other supervised learning technique usable to train a model to predict the geographic position of missing road segments. These techniques can also include unsupervised neural networks (e.g., autoencoders, adversarial networks, etc.), k-means clustering, principal component analysis, and any other unsupervised learning technique usable to train a model to predict the geographic position of missing road segments. In various embodiments, the missing road segment module 230 trains and uses a machine learning pipeline including several models using one of the supervised or self-supervised techniques described above. In the same or different embodiments, the missing road segment 230 may use machine learning techniques to train a machine learning pipeline including one or more models configured to predict the geographic position of missing road segments.

In an embodiment, the missing road segment model is trained by the missing road segment module 230 on images of the surface of the earth labeled to indicate map features upon the images and, in some embodiments, respective electronic map data representing similar regions to the images. The trained missing road segment model receives as input an image of the surface of the earth and segments the image into map features, such as a road segment. The missing road segment module 230 matches the road segments identified by the model to the road segments of the electronic map data corresponding to the geographic region captured by the image. The missing road segment module 230 determines whether any identified road segments are not present in the electronic map data, and if so, identifies each as a missing road segment. The missing road segment module 230 may report the missing road segments to the third-party geographic data service 140 and/or update the geographic data store 250 using the missing road segments.

In some embodiments, the missing road segment module 230 evaluates flagged access points after updating map data using received map data corresponding to missing road segments (e.g., received from the third-party geographic data service 140). In particular, the missing road segment module 230 evaluates the flagged access points to determine whether corresponding trip defects were fully or partially resolved. The missing road segment 230 may evaluate flagged access points periodically after reporting them to the third-party geographic data service 140, such as three or six months after receiving updated map data including the missing road segments. In one embodiment, the missing road segment module 230 re-performs the same evaluation used to flag the access points initially and compares the results. For example, the missing road segment module 230 may determine whether trip metrics for a flagged access point are no longer above or below corresponding defect indicator thresholds.

In the same or a different embodiment, the missing road segment module 230 generates a control group of flagged access points that are not provided to the third-party geographic data service 140 and are used for comparison to flagged access points associated with previously missing road segments received from the third-party geographic data service 140. For instance, the missing road segment module 230 may re-perform the evaluation on the control group and on access points associated with received missing road segments and compare the results to determine whether corresponding trip defects improved. As an example, the missing road segment module 230 may generate a control group by ranking a set of flagged access points according to the degree of one or more determined defects (e.g., based on defects score for the flagged access points). In this case, the missing road segment module 230 generates a control group from a subset of the set of ranked access points. For example, the missing road segment module 230 may select a pre-defined percentage of low ranked access points, such as randomly selecting access points from access points below a rank threshold (e.g., a random 5% of the lowest 80% of ranked access points) or selecting a percentage of the lowest-ranked access points (e.g., the bottom 5%). By using the control group to evaluate flagged access points, the transportation management system 110 avoids determining that trip defects for an access point were fully or partially resolved based on measurements for the same access point from two different time periods, which may be based on contextual factors rather than actual improvement due to the addition of the missing road segment. Additionally, by reporting fewer and more highly ranked access points, the transportation management system 110 increases the likelihood that missing road segments for higher-priority access points are provided by the third-party geographic data service 140 sooner.

The trip data store 240 maintains data describing riders associated with rider devices 120 (e.g., a rider account), drivers associated with driver devices 130 (e.g., a driver account), records of in-progress and completed (i.e., historical) trips coordinated by the transportation management system 110, and any other data relevant to trips facilitated by the transport management system 110. In some embodiments, the trip data store 240 may include multiple data stores for storing one or more specific types of data. Regarding in-progress and completed trips, each trip provided by a driver to a rider is characterized by a set of attributes (or variables), which together form a trip record that is stored in the trip data store 240. The attributes describe aspects of the driver, the rider, and the trip. In one embodiment, each trip record includes a trip identifier (ID), a rider ID, a driver ID, the origin location, the pick-up location, the pick-up spot, the destination location, the duration of the trip, the service type for the trip, estimated time of pick up, actual time of pick-up, driver rating by rider, rider rating by driver, price information, market information, and/or other environmental variables as described below. In some embodiments, the trip record also includes rider and/or driver feedback regarding the pick-up spot. The variables for the trip record can therefore be drawn from multiple sources, including a rider and/or drivers usage history of respective the rider or driver application 135, or one or more specific variables captured and received during each trip.

Regarding data describing drivers, the trip data store 240 stores account and operational information for each driver who participates in the transportation management system 110. For each driver, the trip data store 240 stores one or more database records associated with the driver, including both master data and usage data. In some examples, master data for a driver includes the driver's name, driver's license information, insurance information, vehicle information (year, make, model, vehicle ID, license plate), address information, cell phone number, payment information (e.g., credit card number), sign-up date, driver service type (regular, luxury, van, etc.), device type (e.g., type of cell phone), platform type (e.g., iOS, Android), application ID, and/or application version for the driver application 135).

The trip data store 240 can further store driver availability status information received from the trip management module 210, including whether the driver is available for matching and the location of the driver (which gets updated periodically). When the trip management module 210 receives a transportation request, the trip management module 210 determines, from the trip data store 240, which drivers are potential candidates to pick up the rider for the newly created trip. When the transportation management system 110 marks a trip record as complete, the transportation management system 110 can add the driver back into an inventory of available drivers in the trip data store 240).

The geographic data store 250 stores geographic data used by the transportation management system 110 to facilitate trips. For instance, the geographic data store 250 may store map data, traffic data, access point data, or other geographic information (e.g., received from the third-party geographic data service 140).

### III. Exemplary Visualizations of Map Data with Missing Road Segment

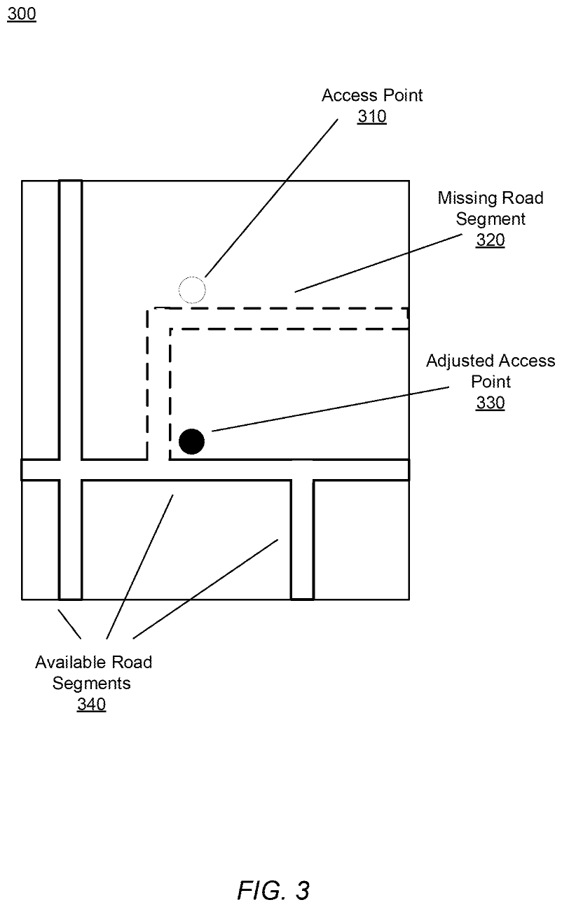

FIG. 3 illustrates an embodiment of a visualization 300 of map data representing an access point 310 associated with a missing road segment 320. In the embodiment shown, the visualization 300 includes the access point 310, the missing road segment 320, the adjusted access point 330, and the available road segments 340. The missing road segment 320 is represented using a dashed line to distinguish it from the available road segments 340, and is further depicted for the purposes of illustration only and may not be visualizable based on the map data because it is missing from the map data. Although only a single access point associated with a single missing road segment are shown in the visualization 300, the map data used by the transportation management system 110 to facilitate trips can include any number of access points with may each be associated with one or more missing road segments.

As shown in FIG. 3, the access point 310 is not accessible from the available road segments 340 that are included in the map data used by the transportation management system 110. The adjusted access point 330 corresponds to a position along one of the available road segments 340 that is the shortest distance from the access point 310. For example, the transportation management system 110 may determine the adjusted access point 330 based on a request from a rider for a trip that uses the access point 310 as a pick-up or drop-off location. In this case, the transportation management system 110 may determine the adjusted access point 330 to use in place of the access point 310 for the requested trip (e.g., by the access point module 220). Similarly, the transportation management system 110 may determine the adjusted access point 330 in order to evaluate an access point distance error for the access point 310 (e.g., by the missing road segment module 230). If the transportation management system 110 flags the access point 310 based one or more trip defects resulting from the missing road segment 320, the transportation management system 110 may take various actions to resolve the trip defects, as described above with reference to the missing road segment module 230.

### IV. Exemplary User Interface

FIG. 4 illustrates an embodiment of a user interface 400 for adjusting a user experience for a driver to account for a missing road segment. For instance, the transportation management system 110 may provide the user interface 400 for display by the driver device 130. In the embodiment shown in FIG. 4, the user interface 400 is a navigation interface assisting a driver in navigating a route for a trip in order to pick-up a rider. In particular, the user interface 400 includes a map overlaid with multiple digital objects representing elements of the route, including the position of the driver, a path along available road segments, a geographic position of the rider (i.e., the position marked “RIDER PICK-UP LOCATION”), and an indicator of the distance between an available road segment and the pick-up location (i.e., the dashed lines). The user interface 400 further includes message notifying the driver that the geographic position of the rider cannot be accessed by available road segments and suggesting that the driver attempt to locate a missing road. Although as depicted the user interface 400 facilitates a pickup of a rider, one skilled in the art will recognize that similar interfaces can be used to facilitate a drop-off of a rider.

The transportation management system 110 may provide the user interface 400 for display by the driver device 130 if the driver device 130 is providing a trip that is associated with an access point that has been flagged (e.g., by the missing road segment module 230, as described above). For example, a rider may request a trip with a pick-up access point that has previously been flagged. In this case, the transportation management system 110 may provide the user interface 400 for display on the driver device 130 that includes the indication of the distance between the available road segment and the access point and the message in order to improve the ability of the driver to more efficiently pick-up the driver. Furthermore, the transportation management system 110 may provide the user interface 400, which displays the position of the actual access point instead of using an adjusted access point (e.g., as may be done if access point were not flagged) in order to encourage the driver to use the suspected missing road segment.

Although as depicted the user interface 400 facilitates a pickup of a rider, one skilled in the art will recognize that similar interfaces can be used to facilitate a drop-off of a rider.

### V. Method for Identifying Missing Road Segments

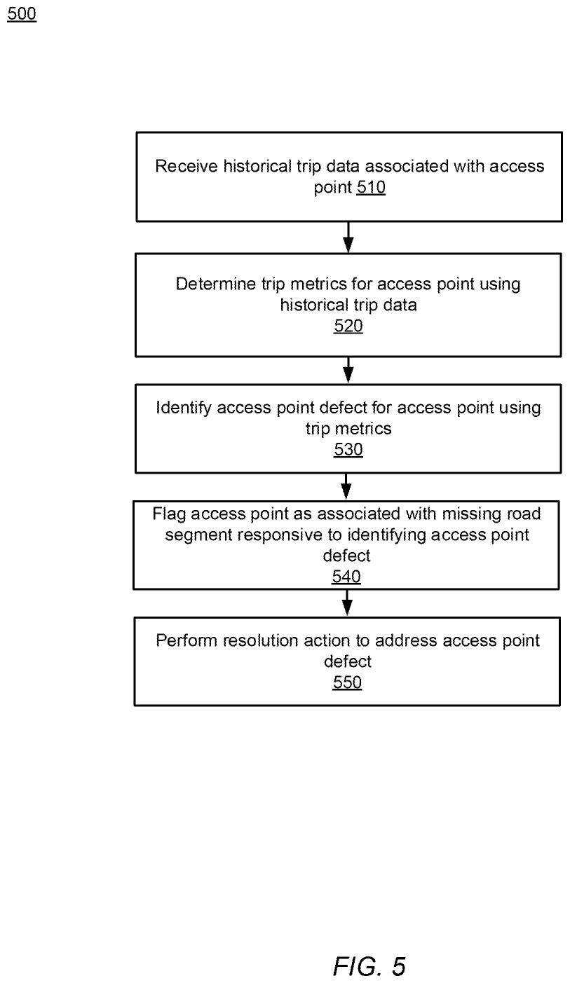

FIG. 5 is a flowchart illustrating an embodiment of a method 500 for identifying a missing road segment associated with an access point. In the embodiment shown, the steps of FIG. 5 are illustrated from the perspective of the transportation management system 110 performing the method 500. However, some or all of the steps may be performed by other entities or components. In addition, some embodiments may perform the steps in parallel, perform the steps in different orders, or perform different steps.

In the embodiment shown in FIG. 5, the method 500 begins with the transportation management system 110 obtaining 510 historical trip data describing a plurality of trips facilitated by the transportation management system using a set of map data, the plurality of trips associated with an access point. For instance, the missing road segment module 230 may retrieve historical trip data from the trip data store 240 collected by the trip management module 210. Using the historical trip data, the transportation management system 110 determines 520 one or more trip metrics for the access point. For example, the missing road segment module 230 may process the historical trip data in order to determine the one or more trip metrics. The one or more trip metrics may include an access point distance error value, a cancellation rate value, an ETA value, or any other trip metrics described herein. Using the one or more trip metrics, the transportation management system 110 identifies 530 an access point defect for the access point, the access point defect indicative of a road segment missing from the set of map data. As an example, the missing road segment module 230 may evaluate the one or more trip metrics using one or more respective access point defect indicator thresholds. As another example the missing road segment module 230 may use a missing road segment model to predict the position of missing road segments using the one or more trip metrics or other data. Responsive to identifying 530 the access point defect, the transportation management system 110 flags 540 the access point as being associated with the missing road segment.

After the access point is flagged, the transportation management system 110 may perform 550 one or more actions to resolve issues for trips associated with the access point that are caused by the missing road segment. For example, the transportation management system 110 may report the missing road segment to the third-party geographic data service 140 or adjust the user experience on a rider device 120 or driver device 130, as described above with reference to the missing road segment module 230.

As such, through the process 500 depicted in FIG. 5, or performed by other processes described herein, the transportation management system 110 improves trip execution by identifying missing road segments and taking actions to resolve issues caused by the missing road segments. In contrast, conventional systems make automatic adjustments to pick-up or drop-off locations, or simply leave riders and drivers to manually coordinate the logistics on their own, resulting in inefficient, error-prone, or canceled trips.

### VI. Exemplary Computer Architecture

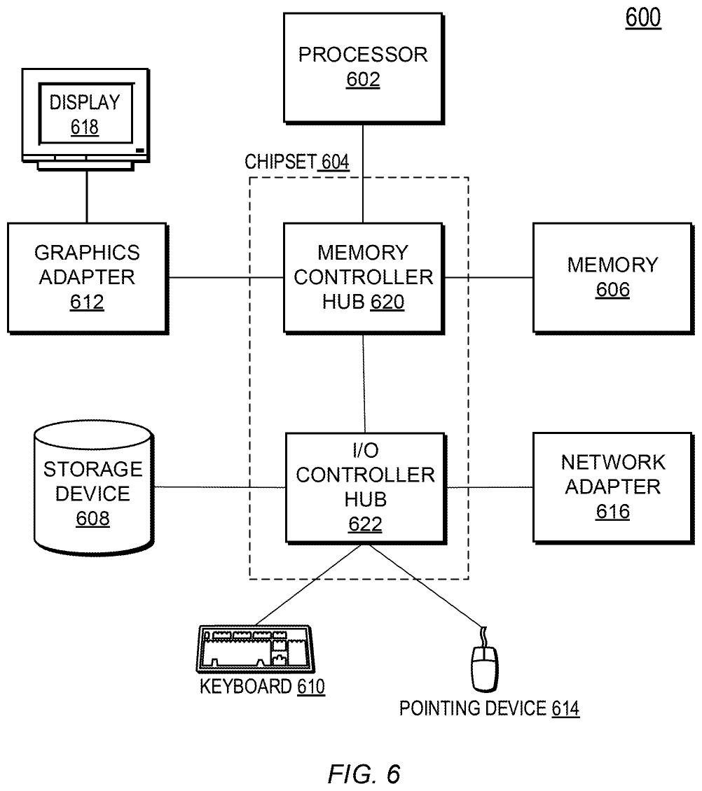

FIG. 6 is a block diagram illustrating physical components of a computer 600 used as part or all of the transportation management system 110, rider device 120, or driver device 130 from FIG. 1, in accordance with an embodiment. Illustrated are at least one processor 602 coupled to a chipset 604. Also coupled to the chipset 604 are a memory 606, a storage device 608, a graphics adapter 612, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The graphics adapter 612 displays images and other information on the display 618. The network adapter 616 couples the computer 600 to a local or wide area network.

As is known in the art, a computer 600 can have different and/or other components than those shown in FIG. 6. In addition, the computer 600 can lack certain illustrated components. In one embodiment, a computer 600, such as a host or smartphone, may lack a graphics adapter 612, and/or display 618, as well as a keyboard 610 or external pointing device 614. Moreover, the storage device 608 can be local and/or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 608, loaded into the memory 606, and executed by the processor 602.

### VII. Additional Considerations

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations while described functionally computationally or logically are understood to be implemented by computer programs or equivalent electrical circuits microcode or the like. Furthermore, it has also proven convenient at times to refer to these arrangements of operations as modules without loss of generality. The described operations and their associated modules may be embodied in software firmware hardware or any combinations thereof.

Any of the steps operations or processes described herein may be performed or implemented with one or more hardware or software modules alone or in combination with other devices. In one embodiment a software module is implemented with a computer program product comprising a computer-readable medium containing computer program code which can be executed by a computer processor for performing any or all of the steps operations or processes described.

Embodiments may also relate to an apparatus for performing the operations herein. This apparatus may be specially constructed for the required purposes and/or it may comprise a general-purpose computing device selectively activated or reconfigured by a computer program stored in the computer. Such a computer program may be stored in a non-transitory tangible computer readable storage medium or any type of media suitable for storing electronic instructions which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process where the information is stored on a non-transitory tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the invention be limited not by this detailed description but rather by any claims that issue on an application based hereon. Accordingly, the disclosure of the embodiments of the invention is intended to be illustrative but not limiting of the scope of the invention which is set forth in the following claims.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method for resolving missing street segments, the method comprising:
obtaining, by a transportation management system, historical trip data describing a plurality of trips facilitated by the transportation management system using a set of map data, the plurality of trips associated with an access point;
determining, using the historical trip data, one or more trip metrics for the access point;
identifying, using the one or more trip metrics, an access point defect for the access point, the access point defect indicative of a road segment missing from the set of map data;
responsive to identifying the access point defect, flagging the access point as being associated with the missing road segment; and
responsive to flagging the access point as being associated with the missing road segment, performing a resolution action to address the access point defect.

2. The method of claim 1, wherein performing the resolution action to address the access point defect comprises:
reporting the missing road segment to a third-party map data service.

3. The method of claim 2, further comprising:
receiving, from the third-party map data service, map data describing the missing road segment; and
updating the set of map data to include the road segment map data describing the missing road segment.

4. The method of claim 3, further comprising:
re-determining the one or more trip metrics for the access points using the updated set of map data including the missing road segment; and
determining whether the access point defect has improved based on the one or more re-determined trip metrics.

5. The method of claim 3, further comprising:
receiving, from a first client device, a trip request for a trip associated with the access point; and
providing, based on the updated set of map data, navigation instructions to a second client device for facilitating the trip, the navigation instructions describing a route including the road segment map data.

6. The method of claim 1, wherein identifying the access point defect comprises:
determining, using the set of map data, an adjusted access point for the access point, the adjusted access point along an available road segment included in the set of map data;
determining an access point distance error using a geographic position of the access point and a geographic position of the adjusted access point; and
identifying the access point defect based on the access point distance error exceeding a defect indicator threshold.

7. The method of claim 1, wherein the one or more trip metrics include one or more of: an access point distance error value, an estimated time of arrival error value, a trip cancellation rate value, a trip request rate value, a total number of trips using the access point value, or a trip duration value.

8. The method of claim 1, further comprising:
receiving, from a first client device, a trip request for a trip associated with the access point; and
providing an interface to a second client device including navigation instructions for facilitating the trip, the navigation interface including a message indicating that the access point cannot be accessed directly due to the missing road segment.

9. The method of claim 1, further comprising:
providing the flagged access point for review by an administrator of the transportation management system; and
receiving confirmation from the administrator that the access point is associated with the missing road segment.

10. A non-transitory computer-readable storage medium storing computer program instructions executable by a processor, the instructions comprising instructions to:
obtain, by a transportation management system, historical trip data describing a plurality of trips facilitated by the transportation management system using a set of map data, the plurality of trips associated with an access point;
determine, using the historical trip data, one or more trip metrics for the access point;
identify, using the one or more trip metrics, an access point defect for the access point, the access point defect indicative of a road segment missing from the set of map data;
responsive to identifying the access point defect, flag the access point as being associated with the missing road segment; and
responsive to flagging the access point as being associated with the missing road segment, perform a resolution action to address the access point defect.

11. The non-transitory computer-readable storage medium of claim 10, wherein performing the resolution action to address the access point defect comprises:
report the missing road segment to a third-party map data service.

12. The non-transitory computer-readable storage medium of claim 11, the instructions further comprising instructions to:
receive, from the third-party map data service, map data describing the missing road segment; and
update the set of map data to include the road segment map data describing the missing road segment.

13. The non-transitory computer-readable storage medium of claim 12, the instructions further comprising instructions to:
re-determine the one or more trip metrics for the access points using the updated set of map data including the missing road segment; and
determine whether the access point defect has improved based on the one or more re-determined trip metrics.

14. The non-transitory computer-readable storage medium of claim 12, the instructions further comprising instructions to:
receive, from a first client device, a trip request for a trip associated with the access point; and
provide, based on the updated set of map data, navigation instructions to a second client device for facilitating the trip, the navigation instructions describing a route including the road segment map data.

15. The non-transitory computer-readable storage medium of claim 10, wherein instructions to identify the access point defect comprise instructions to:
determine, using the set of map data, an adjusted access point for the access point, the adjusted access point along an available road segment included in the set of map data;
determine an access point distance error using a geographic position of the access point and a geographic position of the adjusted access point; and
identify the access point defect based on the access point distance error exceeding a defect indicator threshold.

16. The non-transitory computer-readable storage medium of claim 10, the instructions further comprising instructions to:
receive, from a first client device, a trip request for a trip associated with the access point; and
provide an interface to a second client device including navigation instructions for facilitating the trip, the navigation interface including a message indicating that the access point cannot be accessed directly due to the missing road segment.

17. The non-transitory computer-readable storage medium of claim 10, the instructions further comprising instructions to:
provide the flagged access point for review by an administrator of the transportation management system; and
receive confirmation from the administrator that the access point is associated with the missing road segment.

18. A system comprising:
at least one processor; and
a non-transitory computer-readable storage medium storing computer program instructions executable by the at least one processor, the instructions comprising instructions to:
obtain, by a transportation management system, historical trip data describing a plurality of trips facilitated by the transportation management system using a set of map data, the plurality of trips associated with an access point;
determine, using the historical trip data, one or more trip metrics for the access point;
identify, using the one or more trip metrics, an access point defect for the access point, the access point defect indicative of a road segment missing from the set of map data;
responsive to identifying the access point defect, flag the access point as being associated with the missing road segment; and
responsive to flagging the access point as being associated with the missing road segment, perform a resolution action to address the access point defect.

19. The system of claim 18, wherein performing the resolution action to address the access point defect comprises:
report the missing road segment to a third-party map data service.

20. The system of claim 19, the instructions further comprising instructions to:
receive, from the third-party map data service, map data describing the missing road segment; and
update the set of map data to include the road segment map data describing the missing road segment.
